(19) United States
(12) Patent Application Publication
(10) Pub. No.: US 2018/0175453 A1
(43) Pub. Date: Jun. 21, 2018

(54) ELECTRODE PLATE OF LAMINATED POWER STORAGE ELEMENT, LAMINATED POWER STORAGE ELEMENT, AND METHOD FOR MANUFACTURING ELECTRODE PLATE FOR LAMINATED POWER STORAGE ELEMENT

(71) Applicant: FDK CORPORATION, Tokyo (JP)

(72) Inventors: Yuki Ochiai, Tokyo (JP); Naoaki Nishimura, Tokyo (JP); Daisuke Hirata, Tokyo (JP); Keita Yamamoto, Tokyo (JP)

(73) Assignee: FDK CORPORATION, Tokyo (JP)

(21) Appl. No.: 15/849,565

(22) Filed: Dec. 20, 2017

(30) Foreign Application Priority Data
Dec. 21, 2016 (JP) 2016-248268

(51) Int. Cl. H01M 10/0585; H01M 4/36; H01M 4/62; H01M 4/04; H01M 2/02

(52) U.S. Cl. CPC H01M 10/0585; H01M 4/36; H01M 2/0207; H01M 4/0404; H01M 4/621

(57) ABSTRACT

At least one of positive and negative electrode plates constitutes a flat plate-shaped electrode body in a laminated power storage element. The laminated power storage element includes a casing formed into a flat bag and the electrode body sealed in the casing together with an electrolyte. The at least one of the electrode plates includes: a sheet-shaped metal current collector; and an electrode material. The electrode material includes a powder material including an electrode active material and a binder including an emulsion, the binder added to the powder material. The electrode material is applied, at a predetermined thickness, onto the current collector. The at least one of the electrode plates is formed into a predetermined planar shape by shearing off a peripheral area thereof through a shearing process.

### CROSS-REFERENCE TO RELATED APPLICATION

This application claims the benefit of priority to Japanese Patent Application No. 2016-248268, filed on Dec. 21, 2016, the entire disclosure of which is hereby incorporated by reference herein.

### TECHNICAL FIELD

The present disclosure relates to an electrode plate of a laminated power storage element, a laminated power storage element including the electrode plate, and a method for manufacturing the electrode plate for the laminated power storage element.

### BACKGROUND ART

Recently, for example, an electronic device (hereinafter, the thin electronic device) that is extremely thin while incorporating a power supply, such as an IC card with a one-time password function and a display, an IC card with a display or a tag/token (one-time password generator) has been practically implemented. Downsizing and thinning of a power storage element serving as a power supply (such as a primary battery, a secondary battery, and an electric double layer capacitor) are indispensable requirements to achieve these thin electronic devices. Such a power storage element appropriate for downsizing and thinning includes a laminated power storage element.

FIG. 1A and FIG. 1B illustrate an example of a common laminated power storage element 1. FIG. 1A is an external view of the laminated power storage element 1. FIG. 1B is an exploded perspective view illustrating an outline of an internal structure of the laminated power storage element 1. As illustrated in FIG. 1A, the laminated power storage element 1 has an external appearance of a flat plate shape, wherein a power generating element is sealed in a casing 11 formed of aluminum laminated films 11a and 11b shaped into a flat rectangular bag. In the laminated power storage element 1 described here, a positive electrode terminal plate 23 and a negative electrode terminal plate 33 are guided to the outside from one side 13 of the rectangular casing 11.

Next, the following describes a structure of the laminated power storage element 1 with reference to FIG. 1B. FIG. 1B hatches some members and parts so as to be easily distinguished from other members and parts. As illustrated in FIG. 1B, the casing 11 internally seals an electrode body 10 together with an electrolyte. The electrode body 10 is formed such that a sheet-shaped positive electrode plate 20 and a sheet-shaped negative electrode plate 30 are laminated via a separator 40.

The positive electrode plate 20 is formed such that a slurry positive electrode material 22 including a positive-electrode active material is applied onto one principal surface of a sheet-shaped positive electrode current collector 21 made of a metal foil or a similar material and dried. The positive electrode material 22 is applied onto a surface of the positive electrode current collector 21 on a side opposed to the separator 40. Note that, as long as the laminated power storage element 1 is a primary lithium battery, a manganese dioxide or a similar substance is applicable as a positive-electrode active material.

The negative electrode plate 30 is formed such that a negative electrode material 32 including a negative-electrode active material is disposed to one principal surface of a sheet-shaped negative electrode current collector 31 made of a metal plate, a metal foil, or a similar material. The negative electrode material 32 may be formed such that a slurry material including the negative-electrode active material is applied and dried. Alternatively, when a laminated power storage element 1 is the primary lithium battery, the negative electrode material 32 may be a negative-electrode active material itself made of metallic lithium or a lithium metal.

In any case, the laminated power storage element 1 includes the electrode plates (positive electrode plate 20, negative electrode plate 30) formed such that the electrode materials (positive electrode material 22, negative electrode material 32) are disposed or applied to the sheet-shaped current collectors (positive electrode current collector 21, negative electrode current collector 31) made of a metal foil or a metal plate. In the electrode body 10, the positive electrode material 22 of the positive electrode plate 20 is opposed to the negative electrode material 32 of the negative electrode plate 30 via the separator 40.

The positive electrode terminal plate 23 and the negative electrode terminal plate 33 are coupled to the positive electrode current collector 21 and the negative electrode current collector 31. In an example illustrated in FIG. 1B, tab films 50 made of an insulating resin are bonded so as to sandwich these terminal plates (positive electrode terminal plate 23, negative electrode terminal plate 33), respectively, on a way of extension of the strip-shaped positive electrode terminal plate 23 and negative electrode terminal plate 33 made of a metal plate, a metal foil, or a similar material. Respective end portions, on one end side, of the positive electrode terminal plate 23 and the negative electrode terminal plate 33 are exposed outside the casing 11, while respective end portions thereof on the other end side are coupled to respective parts of the positive electrode current collector 21 and the negative electrode current collector 31 by a method such as an ultrasonic welding.

The casing 11 is configured such that welding peripheral edge regions 12, which are hatched or indicated by a frame of the dotted lines in FIG. 1B, of these two rectangular aluminum laminated films 11a and 11b laminated to each other, are welded by thermal compress ion bonding to seal the interior. As is well-known, the aluminum laminated films 11a and 11b have a structure in which one or more resin layers are laminated on front and back of a metal foil (aluminum foil, stainless steel foil) serving as a base material. Commonly, the aluminum laminated films 11a and 11b have a structure in which a protective layer made of, for example, a polyamide resin is laminated to one surface, and an adhesive layer with thermal weldability made of, for example, a polypropylene is laminated on the other surface.

A procedure for housing the electrode body 10 in the casing 11 while forming these two aluminum laminated films 11a and 11b into this flat-bag-shaped casing 11 is as follows. For example, the electrode body 10 is disposed between these two aluminum laminated films 11a and 11b, which have a rectangular planar shape and are opposed to each other. Three sides of such rectangles are mutually welded to form a bag shape in which one remaining side thereof is open. This one side 13 among these welded three sides is welded, with the terminal plates (positive electrode terminal plate 23, negative electrode terminal plate 33) of both the positive and negative electrode plates (positive electrode plate 20, negative electrode plate 30) protruding outside the casing 11. At this time, the tab films 50 are thermally welded together with the aluminum laminated films 11a and 11b. Accordingly, at this one side 13, the tab films 50 welded to the electrode terminal plates (positive electrode terminal plate 23, negative electrode terminal plate 33) are welded to adhesive layers of the aluminum laminated films 11a and 11b.

Then, an electrolyte is injected between the aluminum laminated films 11a and 11b that are formed into a bag shape with one side open as such, and thereafter the peripheral edge region 12 on the open side is welded. Accordingly, the laminated power storage element 1 illustrated in FIG. 1A is finished.

Note that, for example, Japanese Unexamined Patent Application Publication No. 2016-143582 describes a structure and the like of the laminated power storage element 1. Further, URL: http://www.fdk.co.jp/battery/lithium/lithium_thing.html (FDK Corporation, “Thin Type Primary Lithium Batteries,” online, [searched on Oct. 24, 2016]) (Non-Patent Document 1) describes features, discharge performance, and the like of a thin manganese dioxide primary lithium battery, which is the laminated power storage element actually commercially available. Additionally, URL: http://www.tokyozairyo.co.jp/content/200167563.pdf (Tokyo ZairyoCo., Ltd., “Seventh: Properties and Secret of Rubbers,” [online], [ searched on Oct. 25, 2016]) describes a technique related to the present disclosure.

As described above, the laminated power storage element 1 includes the electrode plates (positive electrode plate 20, negative electrode plate 30) manufactured by respectively disposing or applying the electrode materials (positive electrode material 22, negative electrode material 32) to the sheet-shaped current collectors (positive electrode current collector 21, negative electrode current collector 31).

Such slurry applied to the current collectors (positive electrode current collector 21, negative electrode current collector 31) as the electrode materials (positive electrode material 22, negative electrode material 32) is obtained by adding a binder to a powdery electrode active material and a conductive auxiliary agent and kneading the binder therewith. The sheet-shaped electrode plates (positive electrode plate 20, negative electrode plate 30) are manufactured by applying the slurry electrode material (positive electrode material 22, negative electrode material 32) onto the sheet-shaped current collector (positive electrode current collector 21, negative electrode current collector 31) and then drying the electrode material (positive electrode material 22, negative electrode material 32).

Meanwhile, when the slurry electrode material (positive electrode material 22, negative electrode material 32) is applied to the current collector (positive electrode current collector 21, negative electrode current collector 31), the electrode material (positive electrode material 22, negative electrode material 32) having fluidity at peripheral edges of the current collector (positive electrode current collector 21, negative electrode current collector 31) is condensed such that the electrode material (positive electrode material 22, negative electrode material 32) is thickened at the peripheral areas of the current collector (positive electrode current collector 21, negative electrode current collector 31). That is, the electrode material (positive electrode material 22, negative electrode material 32) fails to achieve uniform thickness across the plane region of the current collector (positive electrode current collector 21, negative electrode current collector 31).

Thus, when the laminated power storage element 1 is assembled using such electrode plates (positive electrode plate 20, negative electrode plate 30) having non-uniform thicknesses, the parts corresponding to the peripheral areas of the current collectors (positive electrode current collector 21, negative electrode current collector 31) increase in thickness. This results in defective products in appearance. Such a partially thickened laminated power storage element 1 causes a possibility of failing to being incorporated into a thin electronic device, such as IC card, whose thickness is strictly specified.

Accordingly, the sheet-shaped electrode plate (positive electrode plate 20, negative electrode plate 30) in the laminated power storage element 1 is usually processed to have a predetermined planar shape and size as follows. The slurry electrode material (positive electrode material 22, negative electrode material 32) is applied to the current collector (positive electrode current collector 21, negative electrode current collector 31) and dried. Thereafter, the peripheral area where the electrode material (positive electrode material 22, negative electrode material 32) has been thickened is sheared off through a punching process. Alternatively, the electrode plate (positive electrode plate 20, negative electrode plate 30) used for the small-sized laminated power storage element 1 having the small area may be manufactured such that the electrode material (positive electrode material 22, negative electrode material 32) is applied onto a large-area current collector (positive electrode current collector 21, negative electrode current collector 31) and this is sheared into a plurality of individual pieces. In either case, the shearing process is performed for the electrode plates (positive electrode plate 20, negative electrode plate 30) included in the laminated power storage element 1. Whether the peripheral area of the electrode plate (positive electrode plate 20, negative electrode plate 30) is sheared off through the shearing process can be determined through measurement of the thickness of the electrode material (positive electrode material 22, negative electrode material 32) at the peripheral area of the electrode plate (positive electrode plate 20, negative electrode plate 30) or through observation of cross-sectional surface of the current collector (positive electrode current collector 21, negative electrode current collector 31) using an electron microscope or the like.

Meanwhile, in the laminated power storage element 1, when the current collector (positive electrode current collector 21, negative electrode current collector 31) coated with the electrode material (positive electrode material 22, negative electrode material 32) is sheared off through the punching process, the electrode material (positive electrode material 22, negative electrode material 32) on the current collector (positive electrode current collector 21, negative electrode current collector 31) may be chipped, thereby being peeled off from the current collector (positive electrode current collector 21, negative electrode current collector 31) or being cracked.

If a fragment of the electrode material (positive electrode material 22, negative electrode material 32) having come off from the current collector (positive electrode current collector 21, negative electrode current collector 31) remains inside the laminated power storage element 1 as it is, an internal short-circuit may occur. Needless to say, if the electrode material (positive electrode material 22, negative electrode material 32) is chipped, the discharge capacity is reduced corresponding to the amount of chipping. In the case of cracking as well, since ionic conduction in the electrode material (positive electrode material 22, negative electrode material 32) is interrupted, the applied electrode material (positive electrode material 22, negative electrode material 32) is partially unused. This may also reduce the discharge capacity.

### SUMMARY

The disclosure to achieve an object is at least one of positive and negative electrode plates constituting a flat plate-shaped electrode body in a laminated power storage element, the laminated power storage element including a casing formed into a flat bag and the electrode body sealed in the casing together with an electrolyte, the at least one of the electrode plates comprising: a sheet-shaped metal current collector; and an electrode material that includes a powder material including an electrode active material and a binder including an emulsion, the binder added to the powder material, the electrode material being applied, at a predetermined thickness, onto the current collector, the at least one of the electrode plates being formed into a predetermined planar shape by shearing off a peripheral area thereof through a shearing process.

Further, the present disclosure is a laminated power storage element comprising: a casing shaped into a flat bag; and

an electrode body formed by laminating a sheet-shaped positive electrode plate and a sheet-shaped negative electrode plate via a separator, the electrode body being sealed in the casing together with an electrolyte, the positive electrode plate and the negative electrode plate each including a sheet-shaped current collector, and an electrode material including an electrode active material, the electrode material being applied, at a predetermined thickness, onto the current collector, at least one of the positive electrode plate and the negative electrode plate being formed into a predetermined planar shape by shearing off a peripheral area of at least one of the electrode plates through a shearing process, the electrode material being obtained by adding a binder including an emulsion to a powder material including an electrode active material.

Further, greater effects can be achieved by configuring the laminated power storage element such that the electrode body is a single-layer type, the electrode body including each one of the positive electrode plate and the negative electrode plate. Further greater effects can be achieved by configuring such that, in each of the electrode plates, the electrode material is applied, at a thickness of 100 μm or more, onto the current collector.

The disclosure is a method for manufacturing an electrode plate of at least one of a positive electrode plate and a negative electrode plate in a laminated power storage element, the laminated power storage element including a casing shaped into a flat bag and an electrode body formed by laminating the sheet-shaped positive electrode plate and the sheet-shaped negative electrode plate via a separator, the electrode body being sealed in the casing together with an electrolyte, the method comprising: a forming step of forming a slurry electrode material including a powdery electrode active material and a binder; an applying step of applying the slurry electrode material onto a sheet-shaped current collector; and a shearing step of drying the slurry electrode material applied onto the current collector, and subsequently shearing the current collector into a predetermined planar shape through a shearing process, the forming step uses an emulsion as the binder, the emulsion including water as a disperse medium.

### BRIEF DESCRIPTION OF DRAWINGS

FIG. 1A is a drawing illustrating a structure of a laminated power storage element.

FIG. 1B is a drawing illustrating a structure of a laminated power storage element.

FIG. 2A is a drawing illustrating an electrode plate of a laminated power storage element.

FIG. 2B is a drawing illustrating an electrode plate of a laminated power storage element.

FIG. 3A is a drawing illustrating an electrode plate of a laminated power storage element.

FIG. 3B is a drawing illustrating an electrode plate of a laminated power storage element.

FIG. 4A is a drawing illustrating an example of a photograph of an electrode plate.

FIG. 4B is a drawing illustrating an example of a photograph of an electrode plate.

### DESCRIPTION OF EMBODIMENTS

Process of Reaching the Present Disclosure

As described above, in a laminated power storage element 1, when an electrode plate (positive electrode plate 20, negative electrode plate 30) which is formed such that a slurry electrode material (positive electrode material 22, negative electrode material 32) is applied onto a sheet-shaped current collector (positive electrode current collector 21, negative electrode current collector 31) and dried, is sheared by a shearing process, damage such as chipping and cracking may occur in the electrode material (positive electrode material 22, negative electrode material 32) on the current collector (positive electrode current collector 21, negative electrode current collector 31).

Thus, after considering a cause of such damage, the inventor has focused on a binder included in the slurry electrode material (positive electrode material 22, negative electrode material 32). In the electrode material (positive electrode material 22, negative electrode material 32), a material contributing to discharge reaction, such as an electrode active material and a conductive auxiliary agent, is originally powdery, and the binder is added to the powder material. This results in a slurry electrode material (positive electrode material 22, negative electrode material 32) having viscosity. The binder used for the electrode material (positive electrode material 22, negative electrode material 32) is a resin material dissolved in an organic solvent such as an N-methylpyrrolidone (NMP) solution of a polyvinylidene fluoride (PVdF).

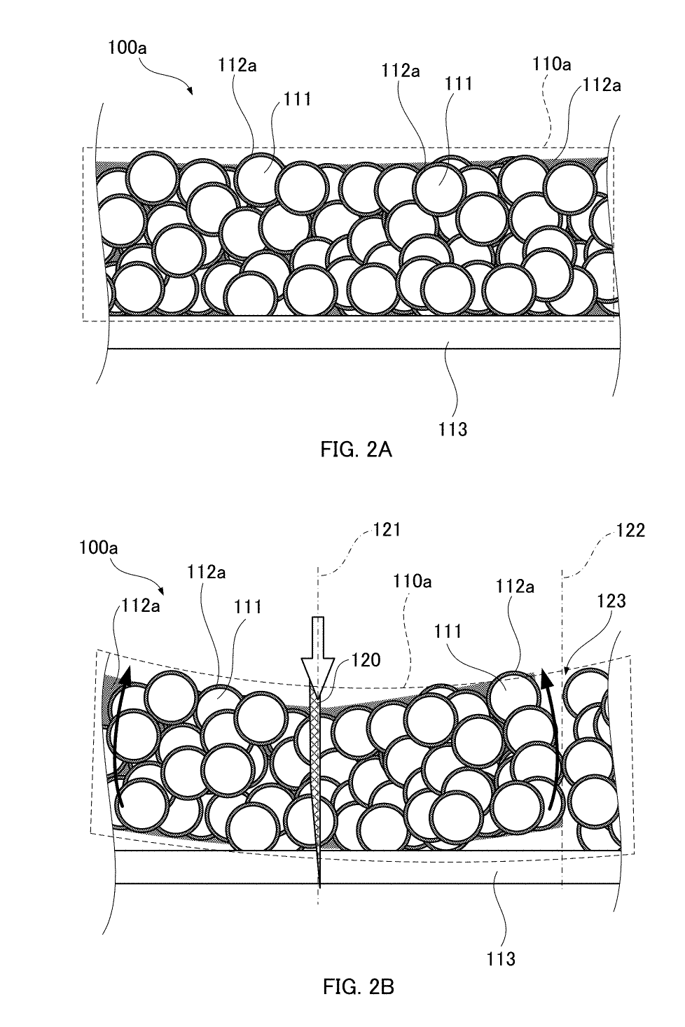

FIG. 2A and FIG. 2B illustrate drawings to describe a cause of the damage. FIG. 2A and FIG. 2B schematically illustrate electrode material 110a (positive electrode material 22, negative electrode material 32) which may cause the aforementioned damage. In the electrode material 110a, while binder 112a illustrated by halftone dots in FIG. 2A and FIG. 2B forms films on the surfaces of particles 111 of the powder material, the binder 112a permeates between the particles 111 in a netlike manner.

FIG. 2A is a cross-sectional view of a sheet-shaped electrode plate 100a using the electrode material 110a and illustrates a state before shearing. FIG. 2B illustrates a deformed state of the electrode material 110a when the electrode plate 100a is being sheared. The following explains a phenomenon of chipping and/or cracking in the electrode material 110a when the electrode plate 100a is being sheared, with reference to FIG. 2A and FIG. 2B.

The binder 112a, which is to be mixed into the electrode material 110a, is dissolved in an organic solvent such as the N-methylpyrrolidone (NMP) solution of the polyvinylidene fluoride (PVdF) and then mixed into the powder material. As illustrated in FIG. 2A, in the slurry electrode material 110a, while the binder 112a illustrated by the halftone dots in FIG. 2A and FIG. 2B forms films on the surfaces of the particles 111 of the powder material, the binder 112a permeates between the respective particles 111 in the netlike manner. Thus, the particles 111 are bound to other particles 111 in a mutual manner at their surfaces, which brings such a state where the particles 111 adjacent to one another do not easily make mutual relative movements. The electrode material 110a dried on a current collector 113 (positive electrode current collector 21, negative electrode current collector 31) is in a hard thick film state.

Next, when the electrode plate 100a is sheared by the punching process, stress applied to the particles 111 of the powder material at the shearing position propagates to the distant particles 111 via the binder 112a uninterruptedly interposed between the particles 111. Thus, as illustrated in FIG. 2B, when a blade 120 of a punching shearing machine is driven in a direction of a hollow arrow in FIG. 2B to shear the electrode material 110a together with the current collector 113, the stress in a direction of warping the electrode material 110a upward is generated at a shearing position 121 and spreads out in a wide range. The stress acts on the hard thick-film shaped electrode material 110a so as to largely warp the electrode material 110a at a position 122 distant from the shearing position 121 as indicated by the bold line arrow in FIG. 2B. In other words, the force attempting to peel off the electrode material 110a from the surface of the current collector 113 acts. A crack 123 occurs in the electrode material 110a at a position at which the stress exceeds strength of adhering to the surface of the current collector 113.

Such an adhesive strength between the current collector 113 and the electrode material 110a lowers at a region from the shearing position 121 to the position 122 at which the crack has occurred due to the above-described stress. Thus, the electrode material 110a may peel off from the current collector 113 in this region. That is, the electrode material 110a is chips at the peripheral area of the current collector 113. Especially, when the electrode plate 100a is sheared into a rectangular flat shape, the electrode material 110a is likely to chip and crack near the corners, since the stress is applied from two directions orthogonal to each other to rectangular corners.

Furthermore, in the single-layer laminated power storage element 1, which includes each one of the positive electrode plate 20 and the negative electrode plate 30 in the electrode body 10, the aforementioned chipping is more likely to occur in the electrode material 110a, in a case where the current collector 113 is coated thick with the electrode material 110a in order to achieve high capacity.

Thus, the inventor has considered such a binding state between the particles 111 where, while the binder is interposed between the respective particles 111 of the powder material, the stress applied to one location does not propagate far away. Then, considering that, if the particles 111 bind not at the surfaces (hereinafter also referred to as surface binding), but at the points (hereinafter also referred to as point binding), the impact does not widely propagate, and chipping in the electrode material 110a can be minimized. Accordingly, the inventor studied a material of the binder 112b to achieve such a point binding state. In view of recent environmental problems, the inventor also studied the binder 112b without the use of an organic solvent. Especially, NMP, which is a solvent for PVdF often used as the binder 112a, has a problem in reproductive toxicity to pregnant women. Thus, environment-friendly and human-friendly binders 112b were also studied. The present disclosure has been made through earnest research based on the above-described considerations and studies.

Binder

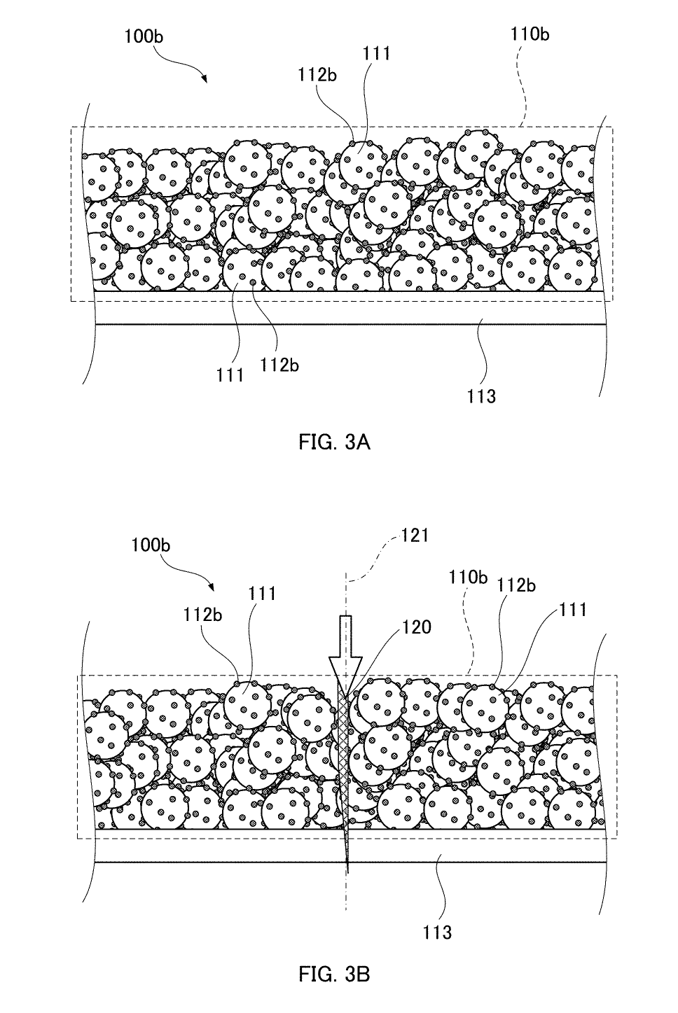

The binder 112b, which is used for an electrode material 110b according to the present disclosure, binds the particles 111 of the powder material together by point binding, and uses an emulsion including a disperse medium of water, considering the influences on the environments and human beings. FIG. 3A and FIG. 3B schematically illustrate the electrode material 110b according to the present disclosure. FIG. 3A and FIG. 3B illustrate cross-sectional views of the sheet-shaped electrode plate 100b (positive electrode plate 20, negative electrode plate 30) formed by coating the current collector 113 with the electrode material 110b. FIG. 3A illustrates the electrode plate 100b before shearing, and FIG. 3B illustrates a stress propagation state at the time of shearing.

In the emulsion, its disperse medium and dispersoid are both liquid. As illustrated in FIG. 3A, the binder 112b according to the present disclosure, i.e., the dispersoid (emulsified particles) constituting the emulsion, contributes to the point binding between the particles 111 of the powder material. As illustrated by the halftone dots in FIG. 3A and FIG. 3B, the binder 112b is disposed to be scattered on the particles 111 of the powder material.

Thus, the particles 111 of the powder material adjacent to one another in the electrode material 110b are bound at the points where such particulate binders 112b are present, which brings about a state where the particles 111 easily make relative movements about the points serving as pivots. That is, the electrode material 110b is in a state of a thick film that is flexible even after drying.

Next, similar to FIG. 2B, when the blade 120 of the punching shearing machine is driven in a direction of a hollow arrow in FIG. 3B to shear the electrode material 110b together with the current collector 113, stress is generated in the electrode material 110b near the shearing position 121. However, since the binders 112b transmitting the stress are disposed in a scattered manner, the stress is less likely to propagate. This can minimize chipping and cracking of the electrode material 110b.

Electrode Plate

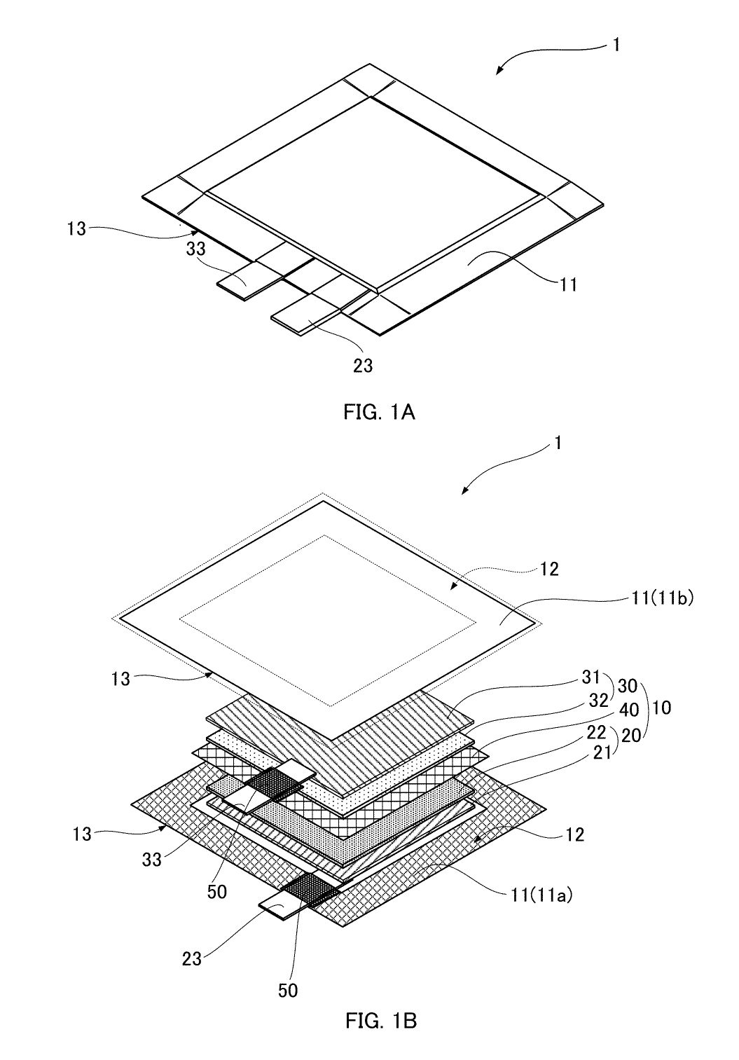

Next, the electrode material 110b using the binders 112b according to the present disclosure were used to manufacture the electrode plate 100b according to an embodiment. Then, it was examined whether chipping occurs in the electrode material 110b during shearing of the electrode plate 100b. Here, the electrode plate 100b corresponding to the positive electrode plate 20 in the laminated power storage element 1 illustrated in FIG. 1B was manufactured.

Specifically, the positive electrode material (hereinafter also referred to as the electrode material) 110b is manufactured such that an electrolytic manganese dioxide (EMD) as a positive-electrode active material, a carbon black as a conductive auxiliary agent, and the binder 112b made from an emulsion styrene-butadiene rubber (SBR) were mixed in proportions of 93 wt %, 3 wt %, and 4 wt %, and slurried using pure water. The electrode material 110b was applied and rolled onto the current collector 113 made of a stainless steel foil having a thickness of 20 μm, so as to have a thickness of 130 μm. After rolling, the electrode material 110b was dried to finish the electrode plate 100b before being sheared. Subsequently, the current collector 113 was sheared so as to have a predetermined planar shape and the predetermined area, thereby manufacturing the electrode plate 100b according to an embodiment. The electrode material 110b in the electrode plate 100b according to an embodiment was examined for occurrence of chipping and/or cracking by visual check. A composition of the electrode material 110b and a structure of the electrode plate 100b is similar to that of the positive electrode plate for the thin type primary lithium battery described in the above-described Non-Patent Document (for example, CF042722U) except for the binder 112b and the thicknesses of the electrode material 110b.

As a comparative example, manufactured was the electrode plate 100a that is identical to the electrode plate 100b according to an embodiment except than the electrode material 110a used the NMP solution of PVdF as the binder 112a. With respect to the electrode plate 100a (hereinafter referred to as the electrode plate 100a according to the comparative example) as well, the electrode material 110a was examined for occurrence of chipping and cracking.

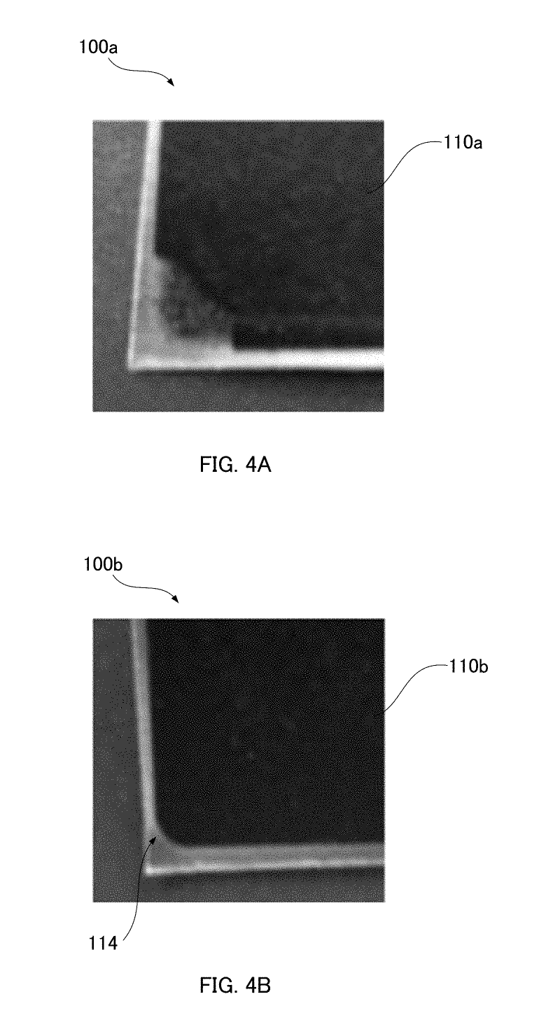

FIG. 4A and FIG. 4B illustrate photographs of the electrode plate 100b according to an embodiment and the electrode plate 100a according to the comparative example. FIG. 4A and FIG. 4B employ reference numerals that are assigned for the corresponding portions in FIG. 3A and FIG. 3B, as reference numerals for respective portions in the electrode plate 100b according to an embodiment and the electrode plate 100a according to the comparative example.

FIG. 4A is the photograph of the electrode plate 100a according to the comparative example, and FIG. 4B is the photograph of the electrode plate 100b according to an embodiment. As illustrated in FIG. 4A and FIG. 4B, chipping occurred in the electrode material 110a in the electrode plate 100a according to the comparative example, whereas neither chipping nor peeling occurred in the electrode material 110b in the electrode plate 100b according to an embodiment. Further, the electrode material 110b is accurately sheared so as to have a planar shape with a rounded rectangular corner 114.

Meanwhile, in the thin type primary lithium battery described in the above-described Non-Patent Document 1, the positive electrode material on the current collector has a thickness of less than 100 μm, which is thinner than the positive electrode material 110b according to an embodiment and the positive electrode material 110a according to the comparative example (130 μm). The electrode plate 100a according to the comparative example has such a structure that is identical to the positive electrode plate of the thin type primary lithium battery described in the above-described Non-Patent Document 1 except for the thickness of the electrode material 110a.

That is, as in the electrode plate 100a according to the comparative example, when the positive electrode material 100a (for example, 100 μm or more) is applied thick onto the current collector of the electrode plate of the thin type primary lithium battery described in the Non-Patent Document 1 in order to increase the discharge capacity, the possibility of chipping and peeling is raised in the punching process when manufacturing the electrode plate 100a. However, the electrode plate 100b according to an embodiment employs the positive electrode material 110b including the binder 112b made of the emulsion. Thus, even if the positive electrode material 110b is applied at a thickness of 130 μm, chipping and/or cracking does not occur during shearing.

That is, the use of the electrode plate 100b according to an embodiment allows the larger discharge capacity for the laminated power storage element 1. Additionally, the electrode plate 100b is less likely to cause an internal short-circuit due to chipping of the electrode material 110b, which ensures excellent safety of the laminated power storage element 1. Note that whether the electrode plate 100b in the laminated power storage element 1 has been manufactured through the punching process or not can be determined by observing a peripheral edge of the current collector 113 using, for example, an electron microscope. Further, whether the binder 112b in the electrode material 110b is the emulsion or not can be determined using a well-known composition analyzer such as an X-ray fluorescence analyzer and an infrared spectroscopy (FT-IR) analyzer.

### OTHER EMBODIMENTS

The raw materials such as the binder 112b and the electrode active material and the conductive auxiliary agent contained in the electrode material 110b constituting the electrode plate 100b according to an embodiment, and the proportion of such materials, and the like are not limited to a sample of an embodiments described above. The electrode active material can be appropriately changed according to the polarity of the electrode (positive electrode, negative electrode) and the type of the power storage element (such as a primary battery and a secondary battery). Similarly, the mixture proportion can be appropriately changed according to the polarity of the electrode (positive electrode, negative electrode) and the type of the power storage element (such as a primary battery and a secondary battery). The emulsion is not limited to the above-described SRB-based emulsion, but may be an acrylic emulsion, a polyvinyl chloride (PVC)-based emulsion, and a similar emulsion. These emulsions can use water as a disperse medium. Needless to say, the electrode plate 100b according to an embodiment is also applicable to the multilayer laminated power storage element 1, which includes the plurality of positive electrode plates 20 and negative electrode plates 30 in the electrode body 10.

What is claimed is:

1. At least one of positive and negative electrode plates constituting a flat plate-shaped electrode body in a laminated power storage element, the laminated power storage element including a casing formed into a flat bag and the electrode body sealed in the casing together with an electrolyte, the at least one of the electrode plates comprising:
a sheet-shaped metal current collector; and
an electrode material that includes
a powder material including an electrode active material, and
a binder including an emulsion, the binder added to the powder material,
the electrode material being applied, at a predetermined thickness, onto the current collector,
the at least one of the electrode plates being formed into a predetermined planar shape by shearing off a peripheral area thereof through a shearing process.

2. A laminated power storage element comprising:
a casing shaped into a flat bag; and
an electrode body formed by laminating a sheet-shaped positive electrode plate and a sheet-shaped negative electrode plate via a separator, the electrode body being sealed in the casing together with an electrolyte,
the positive electrode plate and the negative electrode plate each including
a sheet-shaped current collector, and
an electrode material including an electrode active material, the electrode material being applied, at a predetermined thickness, onto the current collector,
at least one of the positive electrode plate and the negative electrode plate being formed into a predetermined planar shape by shearing off a peripheral area of at least one of the electrode plates through a shearing process,
the electrode material being obtained by adding a binder including an emulsion to a powder material including an electrode active material.

3. The laminated power storage element according to claim 2, wherein
the electrode body is a single-layer type,
the electrode body including each one of the positive electrode plate and the negative electrode plate.

4. The laminated power storage element according to claim 3, wherein
in each of the electrode plates, the electrode material is applied, at a thickness of 100 μm or more, onto the current collector.

5. A method for manufacturing an electrode plate of at least one of a positive electrode plate and a negative electrode plate in a laminated power storage element, the laminated power storage element including a casing shaped into a flat bag and an electrode body formed by laminating the sheet-shaped positive electrode plate and the sheet-shaped negative electrode plate via a separator, the electrode body being sealed in the casing together with an electrolyte, the method comprising:
a forming step of forming a slurry electrode material including a powdery electrode active material and a binder;
an applying step of applying the slurry electrode material onto a sheet-shaped current collector; and
a shearing step of drying the slurry electrode material applied onto the current collector, and subsequently shearing the current collector into a predetermined planar shape through a shearing process,
the forming step using an emulsion as the binder, the emulsion including water as a disperse medium.
